(19) United States
(12) Patent Application Publication
(10) Pub. No.: US 2025/0267226 A1
(43) Pub. Date: Aug. 21, 2025

(54) IMAGE FORMING APPARATUS

(71) Applicants: Yuuta SAITOH, Tokyo (JP); Ryosuke KOHYAMA, Kanagawa (JP)

(72) Inventors: Yuuta SAITOH, Tokyo (JP); Ryosuke KOHYAMA, Kanagawa (JP)

(73) Assignee: Ricoh Company, Ltd., Tokyo (JP)

(21) Appl. No.: 18/999,194

(22) Filed: Dec. 23, 2024

(30) Foreign Application Priority Data
Feb. 16, 2024 (JP) 2024-022059

(51) Int. Cl. H04N 1/00

(52) U.S. Cl. CPC H04N 1/00896; H04N 1/00037; H04N 1/00411; H04N 2201/0094

(57) ABSTRACT

An image forming apparatus includes a scanner control system, a plotter control system, an operation module including a panel, a detector detecting a trigger generated in one of the above systems and the module, energy-saving circuitry, activation circuitry, and display circuitry. The energy-saving circuitry shifts an operation mode of one or more systems of the above systems and the module from an activation mode to an energy-saving mode in response to a receipt of a shift command to shift the operation mode. The activation circuitry receives the trigger from the detector, activates the one or more systems that are associated with the trigger in advance, and shifts the one or more systems from the energy-saving mode to the activation mode. The display circuitry receives the trigger from the detector and controls the panel to display an application associated with the trigger in advance.

### CROSS-REFERENCE TO RELATED APPLICATIONS

This patent application is based on and claims priority pursuant to 35 U.S.C. § 119(a) to Japanese Patent Application No. 2024-022059, filed on Feb. 16, 2024, in the Japan Patent Office, the entire disclosure of which is hereby incorporated by reference herein.

### BACKGROUND

### Technical Field

The present disclosure relates to an image forming apparatus.

### Related Art

The image forming apparatus has an energy-saving mode in which a controller cuts off power supply to most of systems in the image forming apparatus. The controller cancels the energy-saving mode based on an operation such as opening or closing a cover, setting a document on a scanner, or setting a sheet in a tray of a plotter, which is called a trigger, and determines a system to which power is supplied.

### SUMMARY

The present disclosure described herein provides the image forming apparatus including a scanner control system, a plotter control system, an operation module, a detector, energy-saving circuitry, activation circuitry, and display circuitry. The scanner control system controls a scanner. The plotter control system controls a plotter. The relay system controls the scanner control system and the plotter control system and relays a request from an external device. The operation module includes a panel. The detector detects a trigger generated in at least one of the scanner control system, the plotter control system, and the operation module. The energy-saving circuitry is configured to shift an operation mode of, one or more systems of the scanner control system, the plotter control system, the relay system, and the operation module, from an activation mode to an energy-saving mode in response to a receipt of a shift command to shift the operation mode. The activation circuitry is configured to receive a detection result of the trigger detected by the detector, activate the one or more systems associated with the trigger in advance, and shift the one or more systems from the energy-saving mode to the activation mode. The display circuitry is configured to receive the detection result of the trigger detected by the detector and control the panel to display an application associated with the trigger in advance.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram of a configuration of an image forming apparatus according to a first embodiment of the present disclosure;

FIG. 2A is a view of an example of a home screen displayed on the panel of the operation module that is an example of user interfaces;

FIG. 2B is a view of an example displayed on the panel when a copy application is selected, which is also an example of the user interface;

FIG. 3 is a table illustrating an example of combinations of triggers and applications displayed on a panel at a time of an activation and energy-saving mode recovery;

FIG. 4 is a table illustrating another example of combinations of triggers and applications displayed on a panel at the time of the activation and energy-saving mode recovery;

FIG. 5 is a flowchart of an example of an operation at the time of the activation and energy-saving mode recovery in the image forming apparatus of FIG. 1;

FIG. 6 is a diagram of a configuration of an image forming apparatus according to the second embodiment;

FIG. 7 is a diagram of a configuration of an image forming apparatus according to a third embodiment; and

FIG. 8 is a block diagram illustrating an example of a hardware configuration of an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to identical or equivalent components and a description of those components may be simplified or omitted.

The image forming apparatus according to the embodiment of the present disclosure includes multiple systems and has some operation modes such as an energy-saving mode. In the energy-saving mode, power is not supplied to the multiple systems. Based on a predetermined trigger, the energy-saving mode is canceled, and power is supplied to the system, which may be referred to simply as activation and energy-saving recovery in the following description. The embodiments of the present disclosure enhance usability when the energy-saving mode is canceled.

The image forming apparatus includes a scanner control system, a plotter control system, and a relay system that relays the respective systems, and the relay system performs communication with an external device. The scanner control system includes an operation module including a panel operated by a user.

At the time of the activation and energy-saving mode recovery, an application (mode) activated is determined based on the predetermined trigger, a system corresponding to the application is activated, and an application displayed in the panel is switched. A description is given below of the image forming apparatus according to the embodiments in detail.

A first embodiment is described below.

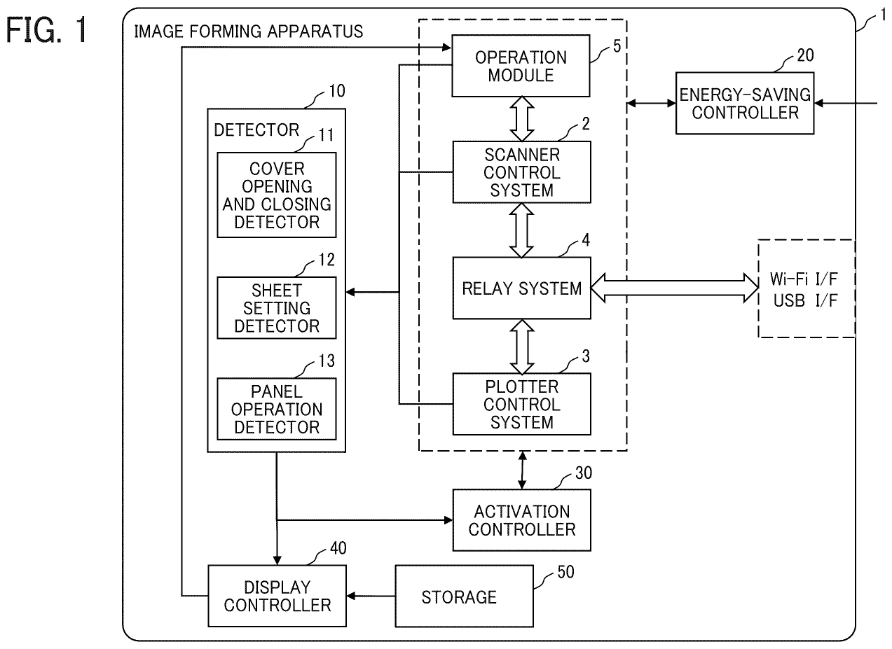

FIG. 1 is a diagram of a configuration of an image forming apparatus according to the first embodiment. The image forming apparatus 1 includes a scanner control system 2 to control a scanner, a plotter control system 3 to control a plotter, a relay system 4 to control the scanner control system 2 and the plotter control system 3 and relay a request from an external device, and an operation module 5 including the panel. The operation module 5 is coupled to the scanner control system 2, and the scanner control system 2 controls the panel.

The scanner control system 2 and the relay system 4 are coupled to each other via a scanner interface (SCN I/F). The plotter control system 3 and the relay system 4 are coupled to each other via a printer interface (PRN I/F). The relay system 4 can be coupled to an external device such as an information processing terminal or a recording medium via an interface such as a universal serial bus (USB) interface (USB I/F) or a wireless fidelity (WiFi) interface (WiFi I/F).

The image forming apparatus 1 includes circuitry such as a controller that controls the above-described systems and the operation module 5 surrounded by a broken line in FIG. 1 to control switching the operation mode between an activation mode and the energy-saving mode and activation of each system. The controller includes a detector 10, an energy-saving controller 20 as energy-saving circuitry, an activation controller 30 as activation circuitry, and a display controller 40 as display circuitry. The power consumption in the energy-saving mode is reduced to be smaller than the power consumption in the activation mode.

The detector 10 detects the predetermined trigger generated in at least one of the scanner control system 2, the plotter control system 3, and the operation module 5. The detector 10 sends a signal corresponding to the predetermined trigger as a detection result detected by the detector 10 to the activation controller 30 and the display controller 40. The predetermined trigger is, for example, at least one of the following processes.
1. Opening or closing the scanner cover in the scanner control system 2,
2. Opening or closing the printer cover in the plotter control system 3,
3. Placing a document in the scanner control system 2,
4. Setting sheets of paper in the plotter control system 3, and
5. Operating on a panel of the operation module 5.
   In other words, the detector detects the trigger generated in response to at least one of the above-described processes.

The detector 10 includes, for example, a cover opening and closing detector 11, a sheet setting detector 12, and a panel operation detector 13. The cover opening and closing detector 11 detects the opening and closing of the scanner cover in the scanner control system 2 and the opening and closing of the plotter cover in the plotter control system 3. The sheet setting detector 12 detects placing the document in the scanner control system 2 and setting the sheets of paper in the plotter control system 3. The panel operation detector 13 detects the operation on the panel of the operation module 5.

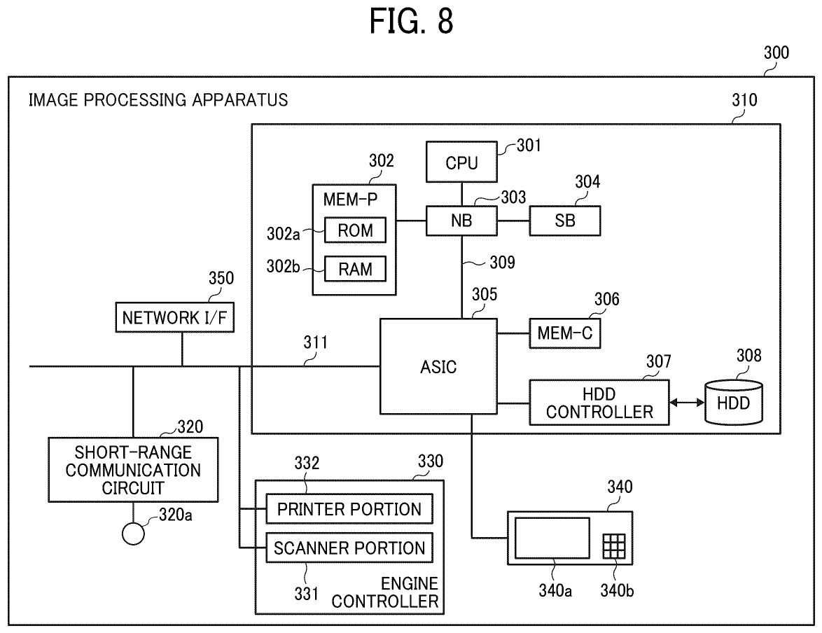

The energy-saving controller 20 receives a shift command to shift the operation mode in the image forming apparatus from the activation mode to the energy-saving mode. In response to a receipt of the shift command to shift the operation mode, the energy-saving controller 20 shifts the operation mode from the activation mode to the energy-saving mode. Specifically, the energy-saving controller 20 shifts the operation mode of one or more systems of the scanner control system, the plotter control system, the relay system, and the operation module, from an activation mode to an energy-saving mode in response to the receipt of the shift command to shift the operation mode. The image forming apparatus 1 operates in either the activation mode or the energy-saving mode. In the activation mode, the image forming apparatus consumes a typical power. In the energy-saving mode, power consumption is reduced. The information indicating whether the image forming apparatus 1 is operating in the activation mode or the energy-saving mode is stored in a storage area that can be referred to by the controller in the image forming apparatus 1. The storage area may be, for example, a system memory (MEM-P) 302 or a local memory (MEM-C) 306 in FIG. 8, which is described below.

In the following description, the controller can read and write data in the storage area. In addition to the system memory (MEM-P) 302 or the local memory (MEM-C) 306 in FIG. 8, the storage area may be, for example, a hard disk drive (HDD) 308 in FIG. 8 or a memory that is detachably attached to a data processing device such as a personal computer outside the image forming apparatus. The controller may read and write data in the memory outside the image forming apparatus via an interface.

When the detector 10 detects execution of the predetermined trigger, the activation controller 30 receives the detection result of the predetermined trigger and controls activation of a system that is associated with the predetermined trigger in advance and controls recovery from the energy-saving mode. The system associated with the predetermined trigger may be stored in advance in a storage area that can be referred to by the activation controller 30, for example. The system associated with the predetermined trigger is at least one of the scanner control system 2, the plotter control system 3, and the relay system 4.

The activation controller 30 controls a power supply circuit to start supplying power to the system associated with the predetermined trigger to which the power supply circuit has not supplied power in the energy-saving mode and shifts the image forming apparatus from the energy-saving mode to the activation mode.

When the detector 10 detects the execution of the predetermined trigger, the display controller 40 receives the detection result of the predetermined trigger and controls the panel of the operation module 5 to display an application that is associated with the predetermined trigger in advance. The application associated with the predetermined trigger may be stored in advance in a storage area that can be referred to by the display controller 40. The image forming apparatus 1 includes storage 50 to store one or more combinations of predetermined triggers and applications. In this case, the display controller 40 selects the application with reference to the one or more combinations of predetermined triggers and applications in the storage 50 and displays the application on the panel.

The following describes the applications displayed on the panel by the display controller 40.

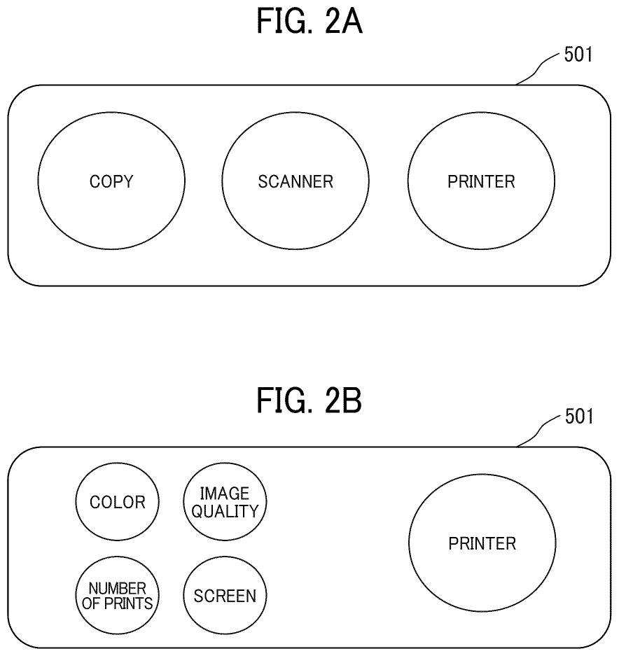

FIG. 2A is a view of an example of a home screen displayed on the panel of the operation module that is an example of user interfaces. FIG. 2B is a view of an example displayed on the panel when a copy application is selected, which is also an example of the user interface. The home screen displays an application list. In FIG. 2A, a panel 501 displays three applications, a copy, a scanner, and a printer. Selecting any one of the applications on the panel 501 changes the panel to display an application screen of the selected application. In FIG. 2B, the panel 501 displays a copy application screen.

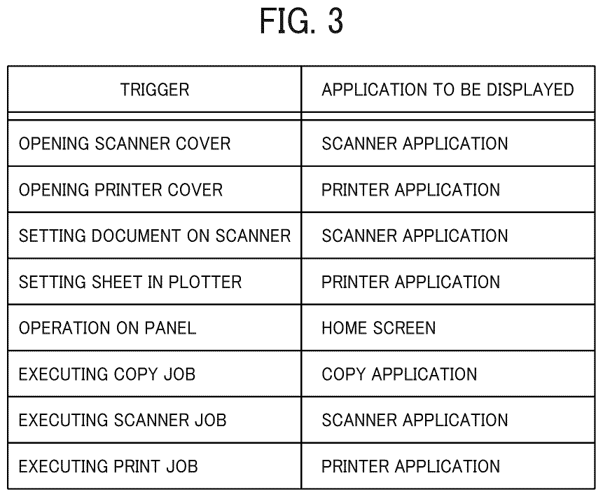

FIG. 3 is a table illustrating an example of combinations of triggers and applications displayed on the panel at the time of the activation and energy-saving mode recovery. FIG. 3 illustrates an example of a combination of the trigger detected at the time of the activation and energy-saving mode recovery and the application that is associated with the detected trigger and displayed on the user interface at the time of the activation and energy-saving mode recovery. The table in FIG. 3 lists up such some examples. At the time of the activation and energy-saving mode recovery, the power supply circuit supplies power to the panel 501 of the operation module 5 to display the application associated with the trigger.

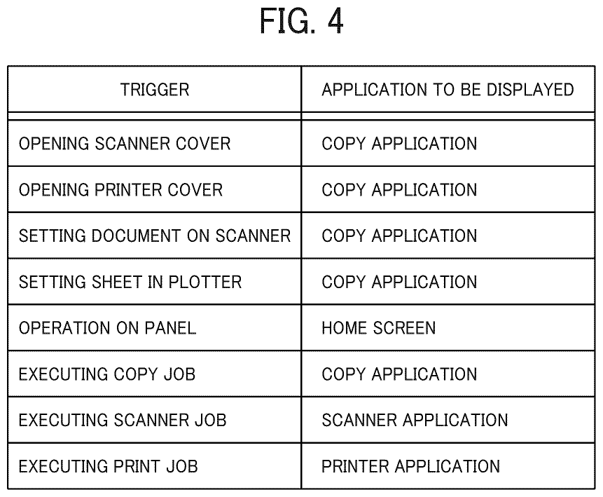

FIG. 4 is a table illustrating another example of combinations of triggers and applications displayed on the panel at the time of the activation and energy-saving mode recovery. The user can change the application displayed on the panel when the user opens the scanner cover, sets the document on the scanner, or sets the sheets of paper in the plotter, from the application listed in FIG. 3 to a copy application. This is because many triggers are used in the copy application.

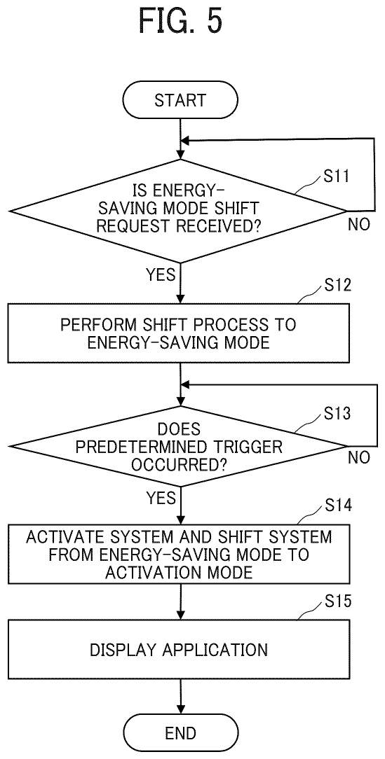

The following describes an example of operation in the image forming apparatus 1 when the image forming apparatus 1 shifts from the activation mode to the energy-saving mode and subsequently shifts from the energy-saving mode to the activation mode. FIG. 5 is a flowchart of the example of the operation at the time of the activation and energy-saving mode recovery in the image forming apparatus 1.

The energy-saving controller 20 is in a standby state until receiving an energy-saving mode shift request that requests shifting the image forming apparatus 1 from the activation mode to the energy-saving mode (NO in step S11). In response to receiving the energy-saving mode shift request (YES in step S11), the energy-saving controller 20 performs a shift process shifting the image forming apparatus 1 from the activation mode to the energy-saving mode (in step S12).

After the image forming apparatus 1 shifts from the activation mode to the energy-saving mode, the detector 10 is in a standby state to detect the occurrence of the predetermined trigger (NO in step S13). In response to detecting the predetermined trigger (YES in step S13), the detector 10 sends the signal corresponding to the detection result to the activation controller 30 and the display controller 40. In step S14, the activation controller 30 activates the system associated with the detected trigger and shifts the system from the energy-saving mode to the activation mode. In step S15, the display controller 40 controls the panel 501 to display the application associated with the detected trigger.

As described above, the controller in the image forming apparatus 1 detects the trigger and controls the panel 501 of the operation module 5 to display the application associated with the trigger in addition to performing the activation and energy-saving mode recovery. The above-described configuration reduces the user's time and effort and enhances the usability at the time of the activation and energy-saving mode recovery.

A second embodiment is described below.

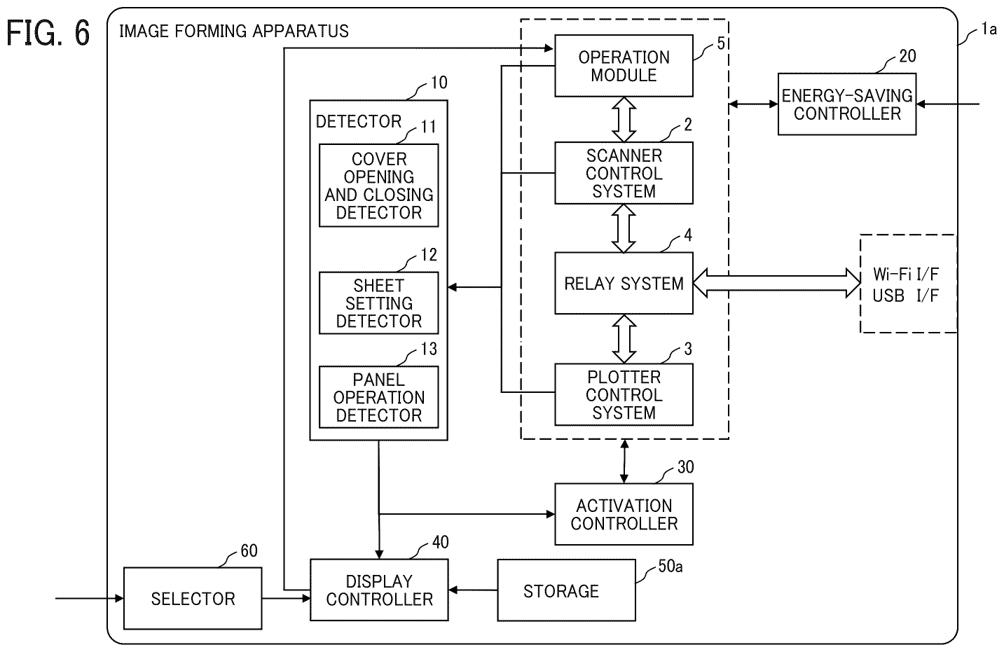

In the present embodiment, the user can select the priority order of the combinations of the triggers and the applications to be displayed at the time of the activation and energy-saving mode recovery. FIG. 6 is a diagram of a configuration of an image forming apparatus according to the second embodiment.

An image forming apparatus 1a includes a selector 60 in addition to the configuration of the image forming apparatus 1 according to the first embodiment. The selector 60 receives information to select the priority order from the outside of the image forming apparatus 1a. The information includes the order of the priority regarding shortening the time until the activation controller 30 starts the activation of the system and the reduction in power consumption. The selector 60 may be configured to receive information input by the user via the panel or information input from the outside of the image forming apparatus 1a via communication. The selector 60 sends the information to select the priority order to the display controller 40.

Storage 50a stores multiple combinations of the triggers and applications associated with the triggers. The multiple combinations are associated with the information to select the priority order. Based on the information to select the priority order, the application associated with the predetermined trigger can be selected and read. The storage 50a stores, for example, the tables illustrated in FIGS. 3 and 4. Using the information to select the priority order, the storage 50a selects which table will be used. Alternatively, the storage 50a may store information including multiple applications associated with one trigger and set based on the information to select the priority order. Using the information to select the priority order, the display controller 40 reads the combination of the predetermined trigger and the application from the storage 50a and displays the combination on the panel.

According to the second embodiment, the panel 501 can display the application associated with the trigger and corresponding to the use state of the user. In this way, the user can select whether to prioritize power (prioritize reduction in power consumption) or to prioritize time at the start of use (prioritize time until the activation controller 30 starts activation of the system).

A third embodiment is described below.

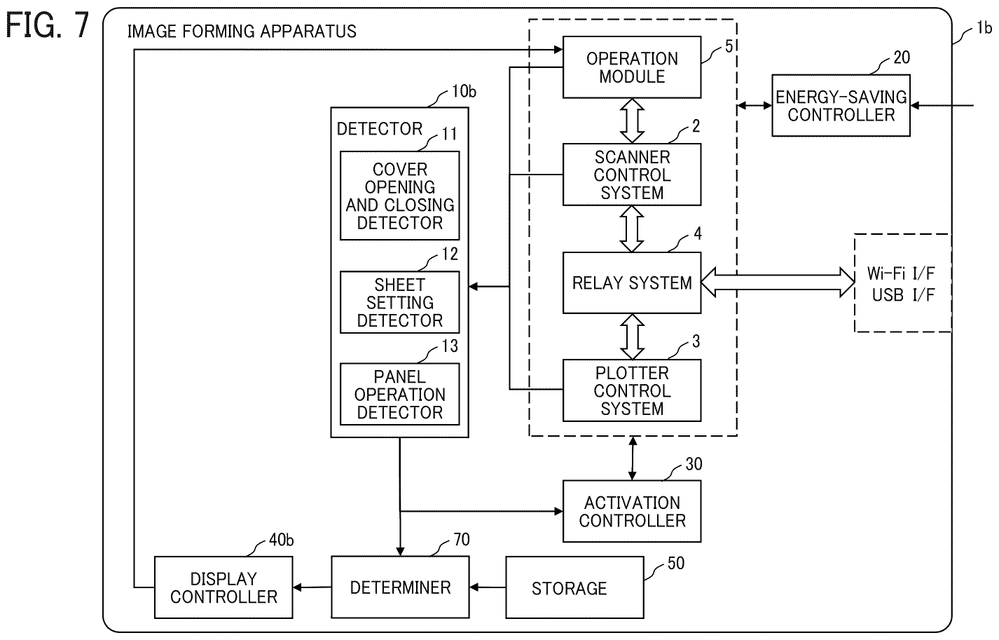

In the present embodiment, the image forming apparatus includes a unit that determines the application to be displayed on the panel based on information in the storage. FIG. 7 is a diagram of a configuration of an image forming apparatus 1b according to the third embodiment.

The image forming apparatus 1b includes a determiner 70 that receives the detection result and determines the application combined with the trigger indicated by the detection result. A detector 10b sends the detection result to the determiner 70. A display controller 40b receives information on the application determined by the determiner 70 and displays the information on the panel.

In the configuration example of FIG. 7, after the detector 10b sends the detection result to the determiner 70, the determiner 70 may determine the system and the application associated with the trigger, notify the activation controller 30 of the system associated with the trigger, and notify the display controller 40 of the application associated with the trigger.

FIG. 7 illustrates the configuration example including the determiner 70 added to the image forming apparatus 1 of FIG. 1, but the determiner 70 may be added to the image forming apparatus 1a of FIG. 6. In this case, the determiner 70 receives information to select the priority order from the selector 60 and reads the application to be displayed from the storage 50a using the information to select the priority order.

Variations are described below.

In the above-described embodiments, the systems activated and associated with the predetermined triggers are stored in advance in the storage area that can be referred to by the activation controller 30, but the present disclosure is not limited to this. The activation controller 30 may have a program including the predetermined triggers and systems to be activated associated with the triggers.

In the above-described embodiments, the combinations of the triggers and the applications are stored in advance in the storage area such as the storage 50 or 50a that can be referred to by the display controller 40, but the present disclosure is not limited to this. The display controller 40 may have a program including the combinations of the predetermined triggers and applications associated with the triggers. In the above cases, the image forming apparatus does not include the above-described storage.

In the above-described embodiments, the controller may be a general-purpose processor in which a dedicated program is installed or a combination of a dedicated hardware part and the general-purpose processor in which a dedicated program is installed.

An image forming apparatus 300 is described below with reference to FIG. 8. The image forming apparatus 300 includes an example of hardware configurations of the image forming apparatuses described in the above embodiments. FIG. 8 is a block diagram illustrating the example of the hardware configuration of the image forming apparatus.

The image forming apparatus 300 is configured as a multifunction peripheral (MFP). The image forming apparatus 300 includes a controller 310, a short-range communication circuit 320, an engine controller 330, an operation panel 340, and a network I/F 350.

The controller 310 controls the entire operation of the image forming apparatus 300 and controls, for example, drawing, communication, and input from the operation panel 340. Specifically, the controller 310 includes a central processing unit (CPU) 301 as a main processor, a system memory (MEM-P) 302, a north bridge (NB) 303, a south bridge (SB) 304, an application-specific integrated circuit (ASIC) 305, a local memory (MEM-C) 306 as a storage, an HDD controller 307, and an HDD 308 as a storage. The NB 303 and the ASIC 305 are connected through an accelerated graphics port (AGP) bus 309.

The CPU 301 is a processor that controls the entire operation of the image forming apparatus 300.

The NB 303 connects the CPU 301 to the MEM-P 302, the SB 304, and the AGP bus 309. The NB 303 includes a memory controller that controls reading or writing of various data from or to the MEM-P 302, a Peripheral Component Interconnect (PCI) master, and an AGP target.

The MEM-P 302 includes a read-only memory (ROM) 302a as a memory that stores programs and data for implementing various functions of the controller 310. The MEM-P 302 further includes a random-access memory (RAM) 302b as a memory that deploys the program and data, or as a drawing memory that stores drawing data for printing.

The program stored in the ROM 302a may be stored in any computer-readable storage (recording) medium, such as a compact disc-read only memory (CD-ROM), compact disc-recordable (CD-R), or digital versatile disc (DVD), in a file format installable or executable by the computer, for distribution.

The SB 304 is a bridge that connects the NB 303 to PCI devices and peripheral devices.

The ASIC 305 is an integrated circuit (IC) dedicated to image processing and includes hardware elements for image processing. The ASIC 305 serves as a bridge to connect the AGP bus 309, a PCI bus 311, the HDD 308, and the MEM-C 306 to each other.

The ASIC 305 includes a PCI target, an AGP master, an arbiter (ARB) as a central processor of the ASIC 305, a memory controller for controlling the MEM-C 306, a plurality of Direct Memory Access Controllers (DMACs) capable of converting coordinates of image data with a hardware logic, and a PCI unit that transfers data between a scanner portion 331 and a printer portion 332 through the PCI bus 311.

The ASIC 305 may be connected to a universal serial bus (USB) interface, or the Institute of Electrical and Electronics Engineers 1394 (IEEE1394) interface.

The MEM-C 306 is a local memory used as a buffer for an image to be copied or a buffer for coding.

The HDD 308 is a storage (memory) that stores image data, font data used in printing, and form data. The HDD controller 307 controls reading from or writing to the HDD 308 according to the control of the CPU 301.

The AGP bus 309 is a bus interface for a graphics accelerator card, which has been proposed to accelerate graphics processing. Through directly accessing the MEM-P 302 by high throughput, the speed of the graphics accelerator card increases.

The short-range communication circuit 320 includes a short-range communication antenna 320a. The short-range communication circuit 320 is a communication circuit that communicates in compliance with a near field communication (NFC) or the BLUETOOTH (registered trademark), for example.

The engine controller 330 includes the scanner portion 331 and the printer portion 332. The scanner portion 331 or the printer portion 332 includes an image processing unit performing image processing such as error diffusion processing and gamma conversion processing.

The operation panel 340 includes a display panel 340a and an operation panel 340b. The display panel 340a is, for example, a touch panel that displays current settings or a selection screen and receives user input. The operation panel 340b includes, for example, a numeric keypad and a start key. The numeric keypad receives assigned values of image forming parameters such as an image density parameter. The start key receives an instruction to start copying, for example.

The operation panel 340 can be used as the panel 501 included in the operation module 5 illustrated in FIG. 2. For example, the scanner control system 2 may control the operation panel 340 as illustrated in FIG. 1.

The image forming apparatus 300 can sequentially switch among a document server function, a copier function, a printer function, and a facsimile function in accordance with input via, for example, an application switch key on the operation panel 340. When the document box function is selected, the image forming apparatus 300 operates in a document box mode. When the copier function is selected, the image forming apparatus 300 operates in a copy mode. When the printer function is selected, the image forming apparatus 300 operates in a printer mode. When the facsimile function is selected, the image forming apparatus 300 operates in a facsimile mode.

The network I/F 350 is an interface for performing data communications using the communication network NT. The short-range communication circuit 320 and the network I/F 350 are electrically connected to the ASIC 305 through the PCI bus 311.

Aspects of the present disclosure are, for example, as follows.

### First Aspect

In a first aspect, an image forming apparatus includes a scanner control system, a plotter control system, an operation module, a detector, energy-saving circuitry, activation circuitry, and display circuitry. The scanner control system controls a scanner. The plotter control system controls a plotter. The relay system controls the scanner control system and the plotter control system and relays a request from an external device. The operation module includes a panel. The detector detects a predetermined trigger that occurs in at least one of the scanner control system, the plotter control system, and the operation module. The energy-saving circuitry receives a command to shift the scanner control system, the plotter control system, the relay system, and the operation module from an activation mode to an energy-saving mode and shifts the scanner control system, the plotter control system, the relay system, and the operation module from the activation mode to the energy-saving mode. The activation circuitry receives a detection result of the predetermined trigger detected by the detector, activates one or more system of the scanner control system, the plotter control system, the relay system, and the operation module that are associated with the predetermined trigger in advance, and shifts the one or more system from the energy-saving mode to the activation mode. The display circuitry receives the detection result of the predetermined trigger detected by the detector and controls the panel to display an application that is associated with the predetermined trigger in advance.

### Second Aspect

In a second aspect, the predetermined trigger in the image forming apparatus according to the first aspect occurs in response to at least one of opening a scanner cover included in the scanner, closing the scanner cover, opening a plotter cover included in the plotter, closing the plotter cover, setting a document on the scanner, setting a sheet in the plotter, and operating the panel.

### Third Aspect

In a third aspect, the image forming apparatus according to the first aspect or the second aspect further includes storage to store multiple combinations of multiple triggers including the predetermined trigger and multiple applications including the application, and the display circuitry selects an application to be displayed on the panel with reference to multiple combinations in the storage.

### Fourth Aspect

In a fourth aspect, the image forming apparatus according to the third aspect further includes a selector that receives information to select a priority order regarding shortening a time until the activation circuitry starts activating one of the scanner control system and the plotter control system and reduction in power consumption, and the storage changes the application associated with the trigger based on the information.

Note that the present disclosure is not limited to the above-described embodiments. Within the scope of the present disclosure, those skilled in the art may change, add, or convert each element of the above-described embodiments. In addition, one or more embodiments can be appropriately combined with another one or more embodiments within a scope of the disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a scanner control system to control a scanner;
a plotter control system to control a plotter;
a relay system to:
control the scanner control system and the plotter control system; and
relay a request from an external device;
an operation module including a panel;
a detector to detect a trigger generated in at least one of the scanner control system, the plotter control system, and the operation module;
energy-saving circuitry configured to shift an operation mode of, one or more systems of the scanner control system, the plotter control system, the relay system, and the operation module, from an activation mode to an energy-saving mode in response to a receipt of a shift command to shift the operation mode;
activation circuitry configured to:
receive a detection result of the trigger detected by the detector;
activate the one or more systems associated with the trigger in advance; and
shift the one or more systems from the energy-saving mode to the activation mode; and
display circuitry configured to:
receive the detection result of the trigger detected by the detector; and
control the panel to display an application associated with the trigger in advance.

2. The image forming apparatus according to claim 1,
wherein the detector detects the trigger generated in response to at least one of:
opening a scanner cover in the scanner;
closing the scanner cover;
opening a plotter cover in the plotter;
closing the plotter cover;
setting a document on the scanner;
setting a sheet in the plotter; and
operating the panel.

3. The image forming apparatus according to claim 1, further comprising storage to store multiple combinations of:
multiple triggers including the trigger; and
multiple applications including the application,
wherein the display circuitry:
selects the application with reference to the multiple combinations; and
displays the application on the panel.

4. The image forming apparatus according to claim 3, further comprising a selector to receive information of a priority order of:
shortening a time until the activation circuitry starts activating one of the scanner control system and the plotter control system; and
a reduction in power consumption,
wherein the storage changes the application associated with the trigger based on the information.
